(19) United States
(12) Patent Application Publication
(10) Pub. No.: US 2019/0101656 A1
(43) Pub. Date: Apr. 4, 2019

(54) Radiometric Measuring Device and Radiometric Measurement System

(71) Applicant: Berthold Technologies GmbH & Co. KG, Bad Wildbad (DE)

(72) Inventor: Dirk MOERMANN, Gernsbach (DE)

(21) Appl. No.: 16/148,164

(22) Filed: Oct. 1, 2018

(30) Foreign Application Priority Data
Oct. 2, 2017 (EP) 17194411.9

(51) Int. Cl. G01T 1/20; G01F 23/00

(52) U.S. Cl. CPC G01T 1/2006; G01F 23/00

(57) ABSTRACT

A radiometric measuring device for measuring a property of a substance, wherein the substance is contained in a hollow body, the radiometric measuring device includes: a bundle of a plurality of scintillator fibers, wherein the bundle is embodied for a longitudinally extending arrangement of the scintillator fibers along the hollow body, a plurality of optoelectronic sensors, wherein the optoelectronic sensors are optically coupled to associated scintillator fibers of the bundle and embodied to convert a light pulse produced by the optically coupled scintillator fiber into an associated electrical sensor signal, and an evaluation unit. The evaluation unit is electrically coupled to the optoelectronic sensors and embodied to sum the sensor signals or signals obtained therefrom by further processing to form a summed signal and embodied to determine the property on the basis of the summed signal.

### CROSS REFERENCE TO RELATED APPLICATION

This application claims priority under 35 U.S.C. § 119 from European Patent Application No. 17194411.9, filed Oct. 2, 2017, the entire disclosure of which is herein expressly incorporated by reference.

### BACKGROUND AND SUMMARY OF THE INVENTION

The invention relates to a radiometric measuring device for measuring a property of a substance, wherein the substance is contained in a hollow body, and to a radiometric measurement system containing such a radiometric measuring device.

Radiometric measuring devices comprising scintillators and optoelectronic sensors for radiation measurements are used in process metrology for the purposes of measuring a property of a substance, for example in the form of a fill level, a position of an interface, a humidity, a density and/or a mass flow, etc. The scintillators and optoelectronic sensors then serve, for example, to determine an energy and/or the intensity of ionizing radiation, with the energy and/or the intensity of the ionizing radiation depending on the property of the substance.

The object of the present invention lies in the provision of a radiometric measuring device which has improved properties in relation to the prior art, in particular which is easy to transport and assemble and which, at the same time, has a high measurement sensitivity and a long measurement range. Furthermore, the object of the invention lies in the provision of a radiometric measurement system including such a radiometric measuring device.

The invention solves this problem by the provision of a radiometric measuring device and by a radiometric measurement system in accordance with embodiments of the invention. Advantageous developments and/or configurations of the invention are described and claimed herein.

The radiometric measuring device according to the invention for measuring a property of a substance, wherein the substance is contained in a hollow body, comprises: a bundle of a plurality of scintillator fibers, a plurality of optoelectronic sensors and an evaluation unit. The bundle is embodied for the longitudinally extending arrangement, in particular straight-lined or extended arrangement, of the scintillator fibers along the hollow body. The optoelectronic sensors are optically coupled to associated scintillator fibers of the bundle and are embodied, in particular in each case, to convert a light pulse produced by the optically coupled scintillator fiber into an associated electrical sensor signal. The evaluation unit is electrically coupled to the optoelectronic sensors and embodied to sum the sensor signals or signals obtained therefrom by further processing to form a summed signal, in particular a sum sensor signal, and embodied to determine the property on the basis of the summed signal.

The radiometric measuring device facilitates a relatively simple transport and a relatively simple assembly at the hollow body, in particular in comparison with a measuring device comprising a scintillator rod. The bundle or the scintillator fibers thereof may be flexible and consequently be wound up during transport, in particular with a winding radius of at most 100 centimeters (cm), in particular at most 50 cm, in particular at most 20 cm, in particular at most 10 cm. Moreover, the bundle or the scintillator fibers thereof can be unwound during the assembly and/or be adapted to a possibly quite complex geometry of the hollow body. Here, the plurality of scintillator fibers facilitates a scintillation volume per unit length of measurement region which need not be smaller in comparison with that of a scintillator rod. However, as a rule, a cross-sectional area of each of the scintillator fibers that, in relative terms, is smaller than a scintillator rod leads to the plurality of scintillator fibers providing relatively fewer light pulses during measurement operation, in particular at the respective end, than a scintillator rod—even in the case of the same scintillation volume per unit length of measurement region. However, a relatively high measurement sensitivity is facilitated by the plurality of optoelectronic sensors. On account of the plurality of sensors, noise and/or a dead time of each individual sensor no longer carries as much weight. The measurement sensitivity can be determined by way of the plurality of scintillator fibers and/or the plurality of sensors. The radiometric measuring device is more sensitive with an increased number of scintillator fibers and/or sensors. Consequently, the measurement sensitivity and the cost can be adapted to the measurement application. The longitudinally extending arrangement of the scintillator fibers, in particular of the assembled scintillator fibers, facilitates a relatively long measurement region.

In particular, each of the scintillator fibers can individually extend in the longitudinal direction, in particular in a straight line. Further, the scintillator fibers can be without interruptions. The radiometric measuring device may have only a single bundle. Bundle may mean that the plurality of scintillator fibers can be combined to form a single unit, in particular a unit that can be handled by, and/or is visible to, the user. Expressed differently: the scintillator fibers need not be separated from one another.

The optoelectronic sensors can be optically coupled to the associated scintillator fibers of the bundle at one end of a respective one of the scintillator fibers. Associated may mean that one of the sensors can be coupled to one of the scintillator fibers, in particular only to a single scintillator fiber, and another of the sensors can be coupled to another scintillator fiber, in particular to only a single other scintillator fiber. In particular, the plurality of scintillator fibers can correspond or be equal to the plurality of sensors. The electrical sensor signal can be an analogue electrical sensor signal, for example in the form of a voltage pulse.

The evaluation unit can determine the property, for example by virtue of being able to evaluate a count rate of the voltage pulses. This count rate may be dependent on the property, for example. In this respect, reference is also made to the relevant specialist literature in relation to the measurement principles of radiometric measuring devices. In particular, the evaluation unit can have, or can be, a microprocessor.

The hollow body can be referred to as a receptacle or a container. The property of the substance can be a fill level, a position of an interface, a humidity, a density and/or a mass flow.

In a development of the invention, the bundle is embodied for the longitudinally extending arrangement of the scintillator fibers along the hollow body to be over a length of at least 1 meter (m), in particular of at least 2 m, in particular of at least 3 m, in particular of at least 4 m, in particular of at least 5 m, in particular of at least 6 m, in particular of at least 7 m. This facilitates a particularly long measurement region. In particular, each of the scintillator fibers can individually extend over a length of at least 1 m.

In a development of the invention, the optoelectronic sensors are embodied, in particular in each case, to convert the light pulse produced by the optically coupled scintillator fiber into an associated digital electric sensor signal. In particular, the digital electrical sensor signal can be a count rate. The evaluation unit can digitally sum the digital sensor signals or signals formed therefrom by further processing, in particular to form an overall count rate. The sensor may comprise sensor electronics. The sensor electronics may comprise an amplifier, a shaper, a discriminator and/or a counter.

One, in particular a plurality, in particular all, of the optoelectronic sensors can respectively have or be only a single photodiode.

In a development of the invention, at least one of the optoelectronic sensors comprises an array of photodiodes. A photodiode facilitates a relatively compact design, a relatively high robustness, in particular in relation to hits, a relatively low supply power, in particular supply voltage, a relatively high lack of sensitivity in relation to magnetic fields, a relatively high quantum efficiency and relatively low costs, in particular in comparison with a photomultiplier tube. In particular, the photodiode can be a semiconductor photodiode, in particular an avalanche photodiode, in particular operated in the Geiger mode. Compared to a single photodiode, the array of photodiodes facilitates a relatively improved signal-to-noise ratio. In particular, the array of photodiodes can be a SiPM (silicon photomultiplier). In particular, a plurality, in particular all, of the sensors may each have an array of photodiodes.

In a development of the invention, at least one of the scintillator fibers has a cross-sectional area of at most 5 square millimeters (mm²), in particular at most 2 mm², in particular at most 1 mm². This facilitates a relatively high flexibility of the scintillator fiber. In particular, a plurality, in particular all, of the scintillator fibers can have a cross-sectional area of at most 5 mm². The cross-sectional area may have a round, in particular circular, or a polygonal, in particular square, form. A cross-sectional area of an associated optoelectronic sensor can be matched to the cross-sectional area of the scintillator fiber, in particular correspond to or equal the latter.

In a development of the invention, at least one of the scintillator fibers comprises polyvinyl toluene (PVT) and/or polystyrene (PS). Polyvinyl toluene (PVT) and polystyrene (PS) each are a material for a so-called plastic scintillator. In particular, a plurality, in particular all, of the scintillator fibers can comprise polyvinyl toluene and/or polystyrene. Additionally, at least one of the scintillator fibers may have a non-scintillating coating. The coating can be embodied in such a way that there is total-internal reflection of the light pulse in the scintillator fiber at an interface between the scintillator material and the coating. This facilitates improved optical guidance of the light pulse to one end of the scintillator fiber and/or, as a result thereof, optical crosstalk between the various scintillator fibers only occurs to a small extent or not at all.

In a development of the invention, the bundle of the plurality of scintillator fibers comprises at least 50, in particular at least 100, in particular at least 200, in particular at least 300, in particular at least 400, scintillator fibers. This facilitates a particularly high scintillation volume per unit length of measurement region. In addition or as an alternative thereto, the plurality of optoelectronic sensors comprises at least 50, in particular at least 100, in particular at least 200, in particular at least 300, in particular at least 400, optoelectronic sensors. This facilitates particularly high measurement sensitivity.

In a development of the invention, each of the optoelectronic sensors is optically coupled to only a single one of the scintillator fibers of the bundle. In addition or as an alternative thereto, each of the scintillator fibers can be coupled to only a single one of the sensors.

In a development of the invention, at least one of the optoelectronic sensors is directly optically coupled to one of the scintillator fibers of the bundle. Expressed differently: the sensor and the scintillator fiber can be arranged immediately adjoining one another. In particular, a plurality, in particular all, of the sensors can each be directly coupled to one of the scintillator fibers.

In a development of the invention, the radiometric measuring device comprises at least one light guide. One of the optoelectronic sensors is optically coupled to one of the scintillator fibers of the bundle by means of the light guide. This allows the sensor to be arranged at a distance from the scintillator fiber. In particular, the light guide can have a non-scintillating embodiment. Moreover, a refractive index of the light guide can be adapted to a refractive index of the scintillator fiber. The radiometric measuring device may have a plurality of light guides. A plurality, in particular all, of the sensors can be coupled in each case to one of the scintillator fibers by means of one of the light guides.

In a development of the invention, at least one of the scintillator fibers is mirrored at one end. This facilitates a relatively higher light yield at one end of the scintillator fiber. In particular, the associated optoelectronic sensor can be optically coupled to the scintillator fiber at the other end. A plurality, in particular all, of the scintillator fibers can each be mirrored at one end.

In a development of the invention, the radiometric measuring device comprises at least one mechanical binding element. The at least one mechanical binding element mechanically binds together the plurality of scintillator fibers to form the bundle. In particular, the binding element can be a tape, in particular an adhesive tape, a tube, in particular a shrinking tube, and/or a cable tie. Furthermore, the binding element can be transparent or transmissive to radiation. Moreover, the binding element can be embodied in such a way that it can hardly have an effect or cannot have an effect on the flexibility of the bundle or of the scintillator fibers thereof.

In a development of the invention, the evaluation unit has an assessment unit. The assessment unit is embodied to assess a respective sensor signal or a signal obtained therefrom by further processing as having or not having an error. Furthermore, the evaluation unit is embodied to sum, in particular only sum, the error-free sensor signals or error-free signals obtained therefrom by further processing to form the summed signal and embodied to form the property of the substance taking account of an error compensation. This facilitates an internal redundancy of the radiometric measuring device. In particular, the assessment part may comprise a selection logic, wherein the selection logic can be embodied to assess a respective sensor signal as a sensor signal having or not having an error. In particular, the plurality of optoelectronic sensors can comprise at least three optoelectronic sensors and the selection logic can be embodied to compare the sensor signals to one another and assess a respective sensor signal as a sensor signal having or not having an error depending on a comparison result. In this respect, reference is also made to the relevant specialist literature relating to redundancy of radiometric measuring devices, in particular to EP 3 064 910 A1.

In a development of the invention, the radiometric measuring device has a common housing. In particular at least the plurality of optoelectronic sensors and the evaluation unit are arranged within the common housing. This facilitates relatively low costs for the radiometric measuring device, in particular in relation to a measuring device having a plurality of housings. In particular, the common housing can be embodied as an explosion-protected housing.

Furthermore, the invention relates to a radiometric measurement system for measuring the property of the substance contained in the hollow body. The radiometric measurement system according to the invention comprises the radiometric measuring device and at least one radiation source.

The radiometric measurement system can facilitate the same advantages as the radiometric measuring device described above.

The radiation source can be embodied for arrangement in the region of the hollow body or at the hollow body. Furthermore, the radiation source can be embodied to emit radiation, in particular ionizing radiation. The radiation source can be a gamma radiation source. The emitted radiation can interact with the substance in the hollow body and can be received by the plurality of scintillator fibers. The scintillator fibers can produce the light pulses from the received radiation.

Additionally, the radiometric measurement system can comprise the hollow body.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a radiometric measurement system according to an embodiment of the invention comprising a radiometric measuring device according to an embodiment of the invention.

FIG. 2 shows a bundle of a plurality of scintillator fibers and a plurality of optoelectronic sensors, which are directly optically coupled, of the measuring device of FIG. 1.

FIG. 3 shows a cross section through one of the scintillator fibers of FIG. 1.

FIG. 4 shows a cross section through one of the sensors of FIG. 1.

FIG. 5 shows a further exemplary embodiment of a scintillator fiber and a sensor, which are optically coupled by means of a light guide, of a radiometric measuring device according to the invention of a radiometric measurement system according to the invention.

### DETAILED DESCRIPTION OF THE DRAWINGS

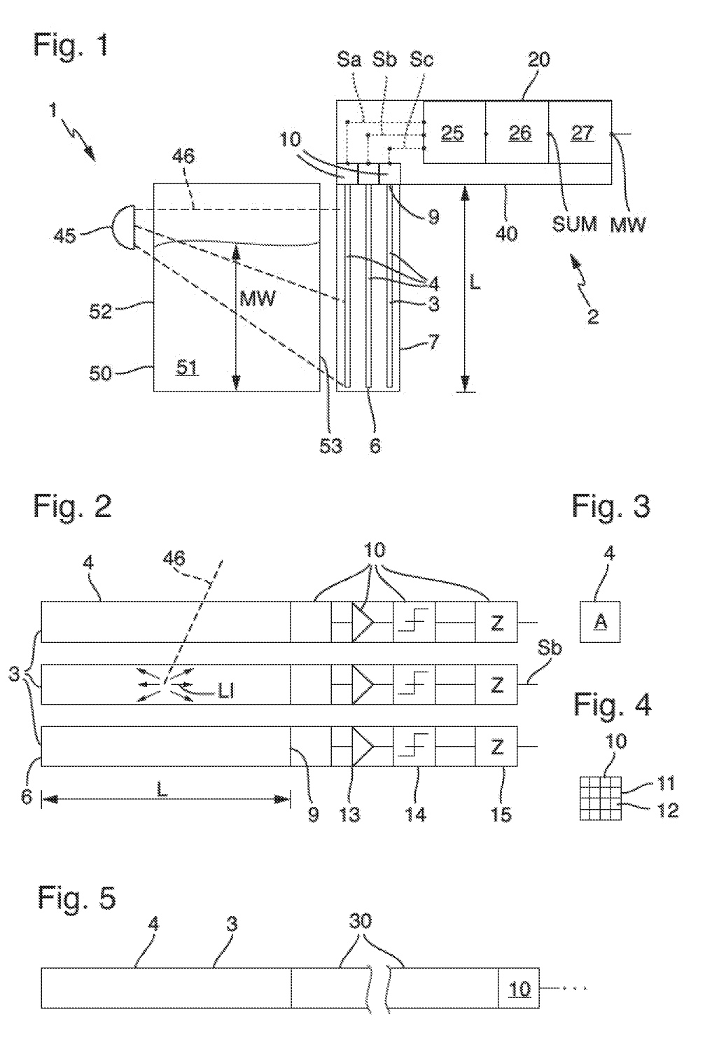

FIG. 1 shows a radiometric measurement system 1 for measuring a property MW of a substance 51. The substance 51 is contained in a hollow body 50. The radiometric measurement system 1 comprises a radiometric measuring device 2.

The radiometric measuring device 2 for measuring the property MW of the substance 51, wherein the substance 51 is contained in the hollow body 50, comprises: a bundle 3 of a plurality of scintillator fibers 4, a plurality of optoelectronic sensors 10 and an evaluation unit 20. The bundle 3 is embodied for the longitudinally extending arrangement, in particular straight-line arrangement, of the scintillator fibers 4 along the hollow body 50. In the shown exemplary embodiment, the scintillator fibers 4 are arranged at the hollow body 50 and extend from top to bottom in FIG. 1 along the hollow body 50, in particular parallel to one another. The optoelectronic sensors 10 are optically coupled to associated scintillator fibers 4 of the bundle 3 and are embodied to convert a light pulse LI produced by the optically coupled scintillator fiber 4 into an associated electrical sensor signal Sa, Sb, Sc, as can be identified in FIG. 2. The evaluation unit 20 is electrically coupled to the optoelectronic sensors 10, as indicated by dotted lines in FIG. 1, and said evaluation unit is embodied to sum the sensor signals Sa, Sb, Sc or signals obtained therefrom by further processing to form a summed signal SUM and to determine the property MW on the basis of the summed signal SUM.

In detail, the bundle 3 or its scintillator fibers 4 extends/extend along the hollow body over a length L of at least 2 m. In alternative exemplary embodiments, the bundle can be embodied for the longitudinally extending arrangement of the scintillator fibers along the hollow body to be over a length of at least 1 m.

Moreover, the radiometric measurement system 1 comprises at least one radiation source 45 in the form of a gamma radiation source. In the shown exemplary embodiment, the radiometric measurement system 1 comprises only a single radiation source 45. In alternative exemplary embodiments, the radiometric measurement system can comprise at least two, in particular at least three, particularly at least four, in particular at least five, radiation sources.

In detail, the radiation source 45 is embodied for arrangement in the region of the hollow body 50. In the shown exemplary embodiment, the radiation source 45 is arranged at one side 52 of the hollow body 50, to the left in FIG. 1. Moreover, the radiation source 45 is embodied to emit radiation 46 in the form of gamma radiation, in particular through the hollow body 50 with the substance 51, as indicated by dashed lines in FIG. 1.

In the shown exemplary embodiment, the bundle 3 of the plurality of scintillator fibers 4 is arranged at an opposite side 53 of the hollow body 50, to the right in FIG. 1.

The emitted radiation 46 can interact with the substance 51 in the hollow body 50 and can be received by the scintillator fibers 4. From the received radiation 46, the scintillator fibers 4 can produce the light pulses LI, as can be identified in FIG. 2.

In the shown exemplary embodiment, the property MW of the substance 51 is a fill level of the substance 51 in the hollow body 50.

In detail, the evaluation unit 20 has a summation unit 26, which is embodied to sum the sensor signals Sa, Sb, Sc or signals obtained therefrom by further processing to form the summed signal SUM. Further, the evaluation unit 20 comprises a conversion unit 27 which is embodied to determine the property MW on the basis of the summed signal SUM, in particular to convert the summed signal SUM into the property MW or a value or an absolute value of the property MW into the fill level in the shown exemplary embodiment.

In the shown exemplary embodiment, the radiometric measuring device 2 comprises only a single bundle 3. In alternative exemplary embodiments, the measuring device can comprise at least two, in particular at least three, bundles.

Moreover, the radiometric measuring device 2 comprises at least one mechanical binding element 7. In the shown exemplary embodiment, the measuring device 2 comprises only a single binding element 7 in the form of a tube. In alternative exemplary embodiments, the measuring device can comprise at least two, in particular at least three, mechanical binding elements. The at least one mechanical binding element 7 mechanically binds together the plurality of scintillator fibers 4 to form the bundle 3.

In detail, the bundle 3 of the plurality of scintillator fibers 4 comprises at least 400 scintillator fibers 4, with only three scintillator fibers 4 being shown in FIGS. 1 and 2. In alternative exemplary embodiments, the bundle of the plurality of scintillator fibers can comprise at least 50 scintillator fibers.

Moreover, the plurality of optoelectronic sensors 10 comprises at least 400 optoelectronic sensors 10, with only three sensors 10 being shown in FIGS. 1 and 2. In alternative exemplary embodiments, the plurality of sensors can comprise at least 50 sensors.

In detail, each of the optoelectronic sensors 10 is optically coupled to only a single one of the scintillator fibers 4 of the bundle 3 or each of the scintillator fibers 4 is coupled to only a single one of the sensors 10. Expressed differently: the plurality of scintillator fibers 4 corresponds to, or equals, the plurality of sensors 10.

At least one, in particular all, of the scintillator fibers 4 in each case has/have a cross-sectional area A, as shown in FIG. 3, of at most 1 mm². In alternative exemplary embodiments, at least one of the scintillator fibers can have a cross-sectional area of at most 5 mm². In the shown exemplary embodiment, the cross-sectional area A has a polygonal, in particular square, form. In alternative exemplary embodiments, the cross-sectional area can have a round, in particular circular, form. In the shown exemplary embodiment, a cross-sectional area of an associated optoelectronic sensor 10 is matched to the cross-sectional area A of the scintillator fiber 4, as can be identified in FIGS. 2 and 4.

At least one, in particular all, of the scintillator fibers 4 comprises a polyvinyl toluene and/or polystyrene.

As can be identified from FIG. 2, the radiation 46 in the form of a single gamma quantum interacts with one of the scintillator fibers 4, the latter producing the light pulse LI as a consequence thereof. The light remains in this scintillator fiber 4 and it is guided by total-internal reflection to the ends 6, 9 of said fiber.

At least one, in particular all, of the scintillator fibers 4 is/are mirrored at one end 6 in each case. The associated optoelectronic sensor 10 is optically coupled to the scintillator fiber 4 at another, opposite end 9 in each case.

In the exemplary embodiment of FIGS. 1 and 2, at least one, in particular all, of the sensors 10 is/are directly optically coupled to one of the scintillator fibers 4 of the bundle 3.

In another exemplary embodiment shown in FIG. 5, the radiometric measuring device 2 comprises at least one light guide 30. One of the optoelectronic sensors 10 is optically coupled to one of the scintillator fibers 4 of the bundle 3 by means of the light guide 30.

At least one, in particular all, of the optoelectronic sensors 10 has/have an array 11 of photodiodes 12 in the form of a SiPM in each case, as can be identified in FIG. 4. In the shown exemplary embodiment, the array 11 has sixteen photodiodes 12. In alternative exemplary embodiments, the array can comprise at least 4 photodiodes, in particular at least 10, in particular at least 50, in particular at least 100.

Moreover, the optoelectronic sensors 10 are embodied to convert the light pulse LI produced by the optically coupled scintillator fiber 4 into an associated digital electrical sensor signal Sa, Sb, Sc in the form of a count rate. In detail, the sensor 10 comprises sensor electronics. The sensor electronics comprise an amplifier 13, a discriminator 14 and a counter 15. In alternative exemplary embodiments, the electrical sensor signal can be an analogue electrical sensor signal, for example in the form of a voltage pulse.

In the shown exemplary embodiment, the evaluation unit 20 or the summation unit 26 thereof is embodied to digitally sum the digital electrical sensor signals Sa, Sb, Sc, in particular to form an overall count rate.

Further, the evaluation unit 20 comprises an assessment unit 25. The assessment unit 25 is embodied to assess a respective sensor signal Sa, Sb, Sc or a signal obtained therefrom by further processing as having or not having an error. Furthermore, the evaluation unit 20 or the summation unit 26 thereof is embodied to sum the error-free sensor signals Sa, Sb, Sc or error-free signals obtained therefrom by further processing to form the summed signal SUM. Moreover, the evaluation unit 20 or the summation unit 26 thereof and/or the conversion unit 27 thereof is embodied to form the property MW of the substance 51 taking account of an error compensation.

Moreover, the radiometric measuring device 2 comprises a common housing 40 in the form of an explosion-protected housing. The plurality of optoelectronic sensors 10 and the evaluation unit 20 are arranged within the common housing 40.

As the shown exemplary embodiments explained above make clear, the invention provides an advantageous radiometric measuring device that has improved properties in relation to the prior art, in particular easy transportation and easy assembly and at the same time a high measurement sensitivity and a long measurement region, and a radiometric measurement system including such a radiometric measuring device.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A radiometric measuring device for measuring a property of a substance, wherein the substance is contained in a hollow body, the radiometric measuring device comprising:
a bundle of a plurality of scintillator fibers, wherein the bundle is configured for a longitudinally extending arrangement of the scintillator fibers along the hollow body;
a plurality of optoelectronic sensors, wherein the optoelectronic sensors are optically coupled to associated scintillator fibers of the bundle and configured to convert a light pulse produced by the optically coupled scintillator fiber into an associated electrical sensor signal; and
an evaluation unit, wherein the evaluation unit is electrically coupled to the optoelectronic sensors and configured to sum the sensor signals or signals obtained therefrom by further processing to form a summed signal and configured to determine the property on the basis of the summed signal.

2. The radiometric measuring device according to claim 1, wherein
the bundle is configured for the longitudinally extending arrangement of the scintillator fibers along the hollow body to be over a length of at least 1 m.

3. The radiometric measuring device according to claim 1, wherein
the optoelectronic sensors are configured to convert the light pulse produced by the optically coupled scintillator fiber into an associated digital electric sensor signal.

4. The radiometric measuring device according to claim 3, wherein
at least one of the optoelectronic sensors comprises an array of photodiodes.

5. The radiometric measuring device according to claim 1, wherein
at least one of the scintillator fibers has a cross-sectional area of at most 5 mm².

6. The radiometric measuring device according to claim 1, wherein
at least one of the scintillator fibers comprises polyvinyl toluene and/or polystyrene.

7. The radiometric measuring device according to claim 1, wherein one or both of:
the bundle of the plurality of scintillator fibers comprises at least 50 scintillator fibers; or
the plurality of optoelectronic sensors comprises at least 50 optoelectronic sensors.

8. The radiometric measuring device according to claim 1, wherein
each of the optoelectronic sensors is optically coupled to only a single one of the scintillator fibers of the bundle.

9. The radiometric measuring device according to claim 1, wherein
at least one of the optoelectronic sensors is directly optically coupled to one of the scintillator fibers of the bundle.

10. The radiometric measuring device according to claim 1, further comprising:
at least one light guide, wherein one of the optoelectronic sensors is optically coupled to one of the scintillator fibers of the bundle via the light guide.

11. The radiometric measuring device according to claim 1, wherein
at least one of the scintillator fibers is mirrored at one end.

12. The radiometric measuring device according to claim 1, further comprising:
at least one mechanical binding element, wherein the at least one mechanical binding element mechanically binds together the plurality of scintillator fibers to form the bundle.

13. The radiometric measuring device according to claim 1, wherein
the evaluation unit comprises an assessment unit, wherein the assessment unit is configured to assess a respective sensor signal or a signal obtained therefrom by further processing as having or not having an error, and
the evaluation unit is configured to sum the error-free sensor signals or error-free signals obtained therefrom by further processing to form the summed signal and to form the property of the substance taking account of an error compensation.

14. The radiometric measuring device according to claim 1, further comprising:
a common housing, wherein the plurality of optoelectronic sensors and the evaluation unit are arranged within the common housing.

15. A radiometric measurement system for measuring a property of a substance contained in a hollow body, said radiometric measurement system comprising:
a radiometric measuring device according to claim 1; and
at least one radiation source.
